(19) United States
(12) Patent Application Publication
(10) Pub. No.: US 2016/0294013 A1
(43) Pub. Date: Oct. 6, 2016

(54) Safe Battery Solvents

(71) Applicant: PRINCESS ENERGY SYSTEMS, INC., Parker, CO (US)

(72) Inventors: John L. Burba, III, Parker, CO (US); Mason K. Harrup, Idaho Falls, ID (US); Thomas A. Luther, Idaho Falls, ID (US)

(73) Assignee: PRINCESS ENERGY SYSTEMS, INC., Parker, CO (US)

(21) Appl. No.: 15/175,652

(22) Filed: Jun. 7, 2016

Related U.S. Application Data
(62) Division of application No. 13/107,586, filed on May 13, 2011, now abandoned.
Application No. 13/107,586 is a continuation-in-part of application No. 12/901,703, filed on Oct. 11, 2010, now abandoned.
Application No. 12/901,703 is a continuation of application No. 12/712,929, filed on Feb. 25, 2010, now abandoned.
Application No. 12/712,929 is a continuation of application No. 12/537,809, filed on Aug. 7, 2009, now abandoned.
(60) Provisional application No. 61/188,244, filed on Aug. 7, 2008.

(51) Int. Cl. H01M 10/0569; H01M 10/0525

(52) U.S. Cl. CPC H01M 10/0569; H01M 10/0525; H01M 2300/0028

(57) ABSTRACT

An ion transporting solvent for use with batteries can be improved by simultaneously shortening a phosphazene compound's pendent groups, eliminating most or all of the distal ion carriers, and randomizing the solvent molecules so as to intentionally disrupt symmetry to the maximum degree possible. The combination of these strategies dramatically improves battery performance to the point where the performance recorded is comparable to batteries using conventional organic solvents.

### STATEMENT REGARDING FEDERALLY SPONSORED RESEARCH OR DEVELOPMENT

This invention was made with government support under subcontract CRADA No. 04-CR-05 under contract No. DE-AC07-05ID14517 awarded by the Battelle Energy Alliance. The government has certain rights in the invention.

### FIELD OF THE INVENTION

The present invention relates generally to an improved ion-transporting solvent for use with common battery electrolyte salts, and specifically, to an improved ion-transporting solvent that reduces the resistances to the metal ion crossing the electrolyte/electrode interface without sacrificing ion solubility or safety.

### BACKGROUND

Lithium ion batteries (“LIBs”) are commonly used in a variety of consumer electronics, including cellular phones, computers, and camcorders. Recently, LIBs have been gaining popularity in other industries, including military, electric vehicle, aerospace, and oil and gas exploration, production, and transportation applications.

All batteries contain an anode, cathode, and an ion carrier electrolyte solution or polymer that transports ions between the electrodes while the battery is charging or discharging. The most typical solvent is a mixture of organic carbonates, and the most common electrolyte is LiPF₆, but LiBF₄ and LiClO₄ are also commonly used. A typical solvent/electrolyte system in a commercial lithium ion battery contains a very high lithium concentration and low viscosity, thereby providing a good environment for ion transport and effective battery function.

However, such a system may be very volatile. For example, depending on the carbonate selected, carbonate solvents may have low flash points. When lithium ions are transported during the charging or discharging process, thermal energy is released. If the battery is under high demand, the resulting heat can be considerable. The vapor pressure of the solvent system increases as the temperature in the battery increases. If the thermal release is greater than the battery's natural cooling, the pressure could exceed the structural limits of the battery case, leading to rupture. The hot vapor may mix with oxygen in the air, and if a heat source is present, may result in a fire.

Batteries, particularly in the oil and gas industry, must be able to operate reliably under the most extreme environmental conditions, including high pressure and high temperature sub-surface and sub-sea regimes. Further, large lithium ion battery systems, such as in the electric vehicle industry, demand a safer, more reliable battery. Batteries using conventional organic carbonates pose serious safety issues, including the potential for explosion and fire.

A detailed description of the principal prior art can be found in U.S. Pat. No. 7,285,362. In the '362 patent, the invention comprises a new ion transporting solvent that maintains low vapor pressure, contains flame-retarding elements, and is non-toxic. The solvent, used in combination with electrolyte salts, replaces the typical carbonate electrolyte solution, creating a safer battery.

According to the prior art, the preferred additive is a cyclic phosphazene, comprising a cyclic core of at least 3 PN repeat units, and most preferably 3-10 repeat units. Each PN unit in the prior art comprises a double bond between the phosphorus and the nitrogen and two pendent groups bound to each phosphorus. Each PN unit is bound to other PN units on either side by single bonds, forming a cyclic core. The pendent groups are covalently bonded to the phosphorus, with the pendent groups comprising ion-carrying groups for enhanced cation mobility. The ion-carrying groups include ethylene oxy and/or ethylene thiol groups. In the prior art, preferred pendent groups comprise 1-10 ethylene units, and the pendent groups attached to a particular phosphazene may have varying ethylene units. Total chain length in the prior art vary widely. The pendent groups may be linear, branched, or any combination thereof.

According to the prior art, the two molecules directly linked to the phosphorous atom form a “pocket” for temporarily holding a cation. For example, a pocket can be found in the O—P—N, O—P—O, S—P—N, and/or an S—P—S pocket. Metal ions may “skip” or “hop” from pocket to pocket within a solvent molecule and/or from pocket to pocket from one molecule to the next molecule, and so on.

The prior art solvents are compatible with both common electrode materials, such as graphite and LiCoO₂, as well as solvating common salts, such as LiPF₆. The prior art discloses the belief that the presence of distal ion carriers (principally distal oxygen and/or distal sulfur atoms, but could include other Group 6B elements) in the pendent groups of the solvent enhances cation mobility. It is hypothesized that the distal atoms contribute to the lithium cation “skipping” and/or “hopping” along an individual solvent molecule and from solvent molecule to solvent molecule.

As those of skill in the pertinent arts will readily appreciate, problems concomitant with these extended arms of distal ion carriers can at times be insurmountable, due to high viscosity and interfacial charge transfer resistances. In particular, these problems are due to the effects of multiple simultaneous coordination between the solvent molecules and the lithium ions.

Such coordination comes in two forms. First, there arises single molecule chelations wherein the lithium molecule has multiple coordinating atoms from the same solvent molecule, either inter- or intra-pendent group, or both. This leads to resistances to the lithium ion crossing the electrolyte/electrode interface that are much higher than anticipated in the prior art. Secondly, there arises the phenomenon of simultaneous coordination from two or more different solvent molecules. This coordination creates transient solvent molecule “crosslinks” that serve to dramatically increase the viscosity of the system, creating additional resistance to the bulk transport of lithium ions through the system.

There is, therefore, a need for new formulations of safe battery solvents with decreased viscosity and decreased resistance to lithium ion transport across the electrolyte/electrode interface, without sacrificing lithium ion solubility.

### SUMMARY OF THE INVENTION

A method of improving battery performance and safety is provided the method including providing a battery having a cathode, an anode, a solvent including at least one cyclic phosphazene compound, and an electrolyte salt; wherein the cyclic phosphazene compound includes associated pendent chemical chains and distal ion carriers and formed by the steps of (1) shortening said associated pendant chemical chains; (2) removing substantially all said distal ion carriers; and (3) randomizing said pendent chemical chains in order to disrupt symmetry of said cyclic phosphazene compound.

Batteries comprising the structure rendered by the above methodology and cyclic compound phosphazene isolated from a battery environment are also described and/or claimed.

### BRIEF DESCRIPTION OF DRAWINGS

FIG. 1 is a table listing seven representative formulations of a compound suitable for use as a battery solvent.

FIG. 2 is a table showing the representative formulations having experienced a dramatic reduction in viscosity, particularly when saturated with lithium salt.

FIG. 3 shows that in the representative compounds, the solubility of the lithium salts did not drop as would have been expected under the teachings of the prior art.

FIG. 4 shows a specific example formulation according to the invention, comprising a plurality of reactions demonstrating the method of the claimed invention.

### DETAILED DESCRIPTION

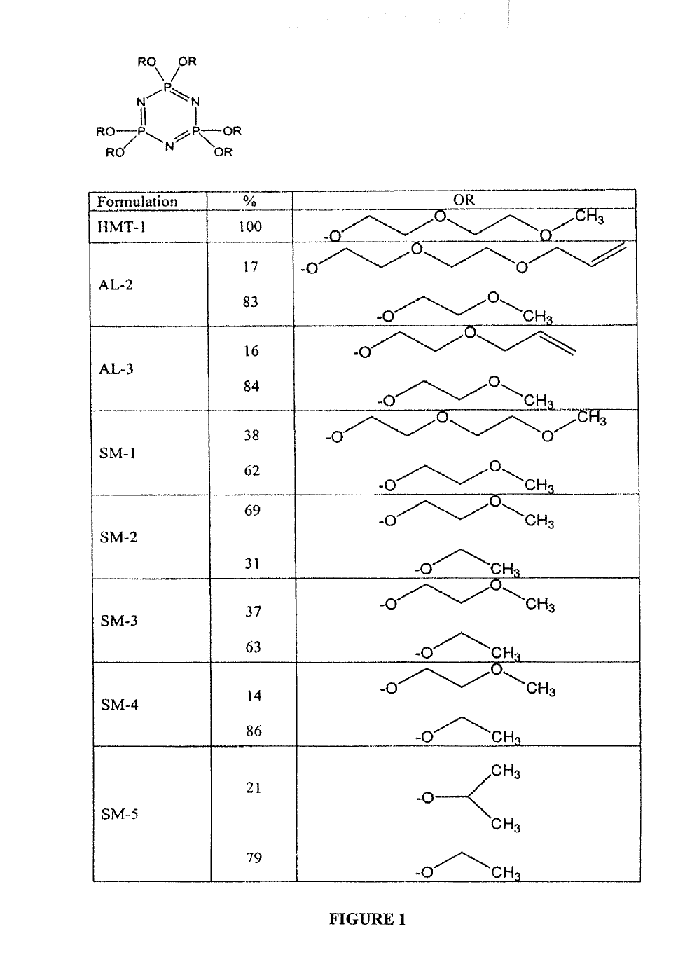

The present invention overcomes the deficiencies in the prior art by simultaneously shortening the pendent groups, eliminating most or all of the distal ion carriers, and randomizing the solvent molecules so as to intentionally disrupt symmetry to the maximum degree possible. The combination of these strategies dramatically improves battery performance to the point where the performance recorded is comparable to batteries using conventional organic solvents. The invention centers upon the improvement of the compound taught by the prior art, namely hexa-MEEP-T. In total, seven representative formulations were developed that improved upon hexa-MEEP-T as a battery solvent, though those of skill in the art will appreciate that many others are possible and will still fall within the scope of this disclosure. The formulations presented are described in FIG. 1.

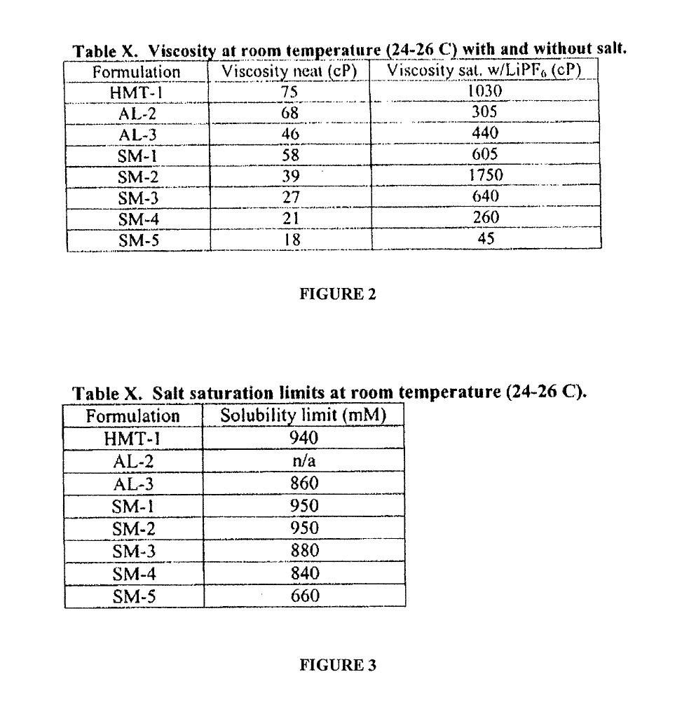

As shown in FIG. 2, in contrast to the prior art, particularly hexa-MEEP-T, the new formulations experience a dramatic reduction in viscosity, particularly when saturated with a lithium salt, typically LiPF₆. As shown in FIG. 3, the solubility of the lithium salts did not drop nearly as precipitously as was expected from the teachings of the prior art. This is postulated to be due to the direct association of the phosphazene nitrogen with the lithium ion, especially in the smallest systems where the nitrogen centers are the most sterically exposed.

A further aspect of the invention builds upon the concepts of pendent group randomization to reduce symmetry. While differing pendent arms may be incorporated into a single formulation, the performance can be further improved by physically admixing two or more phosphazene formulations to produce a blended formulation. In a further embodiment, a percentage of compatible carbonate solvent molecules are incorporated to aid in the disruption of solvent self-association and transient solvent-ion-solvent agglomerations already known to reduce performance. The phosphazene composition of the blend may range, for example, from about 0.05% to about 99%. Even a small percentage of phosphazene or blended carbonate phosphazene results in a significantly improved safety performance.

It was indeed counter-intuitive to one skilled in the art that the removal of ion carriers that are critical for facile ion mobility would in fact forge improvements in phosphazene liquid systems. Also, molecular symmetry or lack thereof was not previously known to have a meaningful effect on the performance of these solvent systems. Lastly, it was unanticipated that exposure of the phosphazene skeleton could keep lithium salt levels high enough to be practical with a significant fraction of the long pendent groups containing high numbers of distal ion carriers removed.

### Example Formulation

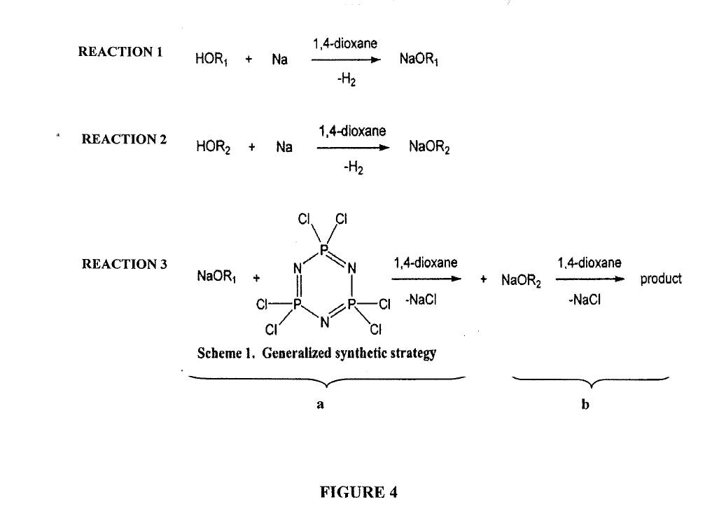

To produce the new formulations, in one embodiment, an organic aprotic solvent, such as 1,4-dioxane, is mixed with an alkali metal or alkali metal hydride to form a reactive alkoxide from its corresponding alcohol as shown in Reaction 1 in FIG. 4. While not particularly described, the same principles enumerated herein apply to thioalkoxides. A solution of percholrophosphazene is added to the reactive alkoxide, and the compound self-assembles, forming a phosphazene compound with a by-product of sodium chloride as shown in Reaction 3a in FIG. 4. Where two or more pendent groups are to be incorporated into the same formulation, the alkoxides and/or thioalkoxides are formed in separate reaction vessels, as shown in Reaction 1 and Reaction 2 in FIG. 4.

Then, the perchlorophosphazene solution is added to the minor component solution, as shown in Reaction 3a of FIG. 4. After attachment of the minor pendent arms is complete, an excess of the major component is added to the reaction, and the synthesis is allowed to go to completion as shown in Reaction 3b of FIG. 4, thereby resulting in the final desired product.

After the solvent is removed, the resultant product is isolated and purified via extraction with basic water. The product is then dried in a vacuum/argon oven for many hours and transferred in a sealed container to an argon glovebox.

The foregoing specification is provided for illustrative purposes only, and is not intended to describe all possible aspects of the present invention. Moreover, while the invention has been shown and described in detail with respect to several exemplary embodiments, those of ordinary skill in the art will appreciate that minor changes to the description, and various other modifications, omissions, and additions may also be made without departing from the spirit or scope thereof. It is envisioned that multiple combinations of phosphazene compounds, incorporating various lengths of pendent arms can be created with similar results.

1. A battery comprising:
a cathode, an anode, a solvent comprising at least one cyclic phosphazene compound, and an electrolyte salt; said cyclic phosphazene compound comprising:
a cyclic backbone of alternating phosphorus atoms and nitrogen atoms and two associated pendent chemical chains bound to each of said phosphorus atoms,
wherein each of said associated pendent chemical chains comprise no more than ten skeletal atoms; at least one of said associated pendent chemical chains comprises no more than four skeletal atoms; each of said skeletal atoms chosen from the group consisting of carbon, oxygen, and sulfur; and each of said skeletal atoms bound directly to said phosphorous atoms chosen from the group consisting of oxygen and sulfur.

2. The battery of claim 1, wherein the electrolyte salt is added in an amount sufficient to saturate the cyclic phosphazene compound.

3. The battery of claim 1, wherein said electrolyte salt is a lithium salt.

4. The battery of claim 1, further comprising a plurality of compatible carbonate solvent molecules.

5. The battery of claim 4, wherein said compatible carbonate solvent molecules are added in an amount comprising between about 1% and about 99.95% of the total chemical solvent composition.

6. The battery of claim 1, further wherein at least one of said associated pendent chemical chains comprises no more than two skeletal atoms.

7. The battery of claim 1, further wherein at least one of said associated pendent chemical chains comprises between two and four skeletal atoms.

8. The battery of claim 1, further wherein no more than three of said skeletal atoms in at least one of said associated pendent chemical chains are selected from the group consisting of oxygen and sulfur.

9. A battery, comprising:
a cathode, an anode, a solvent comprising at least one cyclic phosphazene compound, and an electrolyte salt; said cyclic phosphazene compound comprising:
a cyclic backbone of alternating phosphorus atoms and nitrogen atoms and two associated pendent chemical chains bound to each of said phosphorus atoms,
wherein said associated pendent chemical chains comprise between zero and three distal ion carriers; and at least one of said associated pendent chemical chains comprises zero distal ion carriers.

10. The battery of claim 9, wherein each of said distal ion carriers are chosen from the group consisting of oxygen and sulfur.
